(19) United States
(12) Patent Application Publication
(10) Pub. No.: US 2010/0312665 A1
(43) Pub. Date: Dec. 9, 2010

(54) METHOD AND APPARATUS FOR RETRIEVAL AND NORMALIZATION OF THIRD PARTY LISTINGS

(76) Inventor: Reza Bundy, Venice, CA (US)

Correspondence Address: DLA PIPER US LLP, 1999 AVENUE OF THE STARS, SUITE 400, LOS ANGELES, CA, 90067-6023, US

(21) Appl. No.: 12/754,510

(22) Filed: Apr. 5, 2010

Related U.S. Application Data
(63) Continuation-in-part of application No. 12/191,294, filed on Aug. 13, 2008.
(60) Provisional application No. 61/166,679, filed on Apr. 3, 2009.

(51) Int. Cl. G06Q 30/00

(52) U.S. Cl. 705/26.8

(57) ABSTRACT

The system provides a method an apparatus for retrieving and normalizing third party listings. The system allows a user to use a single transaction system to search multiple sources of listings. Listings that are from outside the system (third party listings) are normalized by translating the listings into the format of the local system. The creator of the third party listing (i.e. the seller) is contacted and offered the chance to become a listing party on the local system. The local system presents the seller with a plurality of questions that aid in completing a more comprehensive and sellable listing. The system rewards disclosure on the part of the third party lister by providing a richer listing on the local system.

This is a continuation-in-part of U.S. patent application Ser. No. 12/191,294 filed on Oct. 27, 2008 entitled “Method and Apparatus for Implementing a Peer-to-Peer System” and assigned to the assignee of the present application. This patent application claims priority to U.S. Provisional Patent Application 61/166,679 filed Apr. 3, 2009 which is incorporated by reference herein in its entirety.

### BACKGROUND OF THE SYSTEM

There have been a number of system to allow peer to peer transaction of products and services. By peer to peer in this application we refer to non-commercial sales between individuals. One example of a peer to peer transaction is the purchase or sale of an automobile between an owner of the automobile and an individual. In the past this has involved the placing of classified advertisements in some media such as a newspaper, a used vehicle focused publication, or on the internet. Some transactions are implemented via auction sites such as eBay.

There are a number of disadvantages of prior art systems for implementing peer to peer transactions. On the seller side, problems include marketing, exposure to strangers, multiple contacts from buyers, unqualified buyers, unfamiliar paperwork, and long cycle times. On the buyer side, problems include connecting with the seller, unavailability of the vehicle, unknown level of trust in the condition of the vehicle, lack of commercial financing and insurance, and lack of clean title.

Another disadvantage of prior art systems is the inability to easily search multiple sources of transactions at the same time. A user is required to use each system separately and cannot be sure if listings are new or duplicates. Further, each prior art system uses its own presentation style and format, so a user must be able to sort through a number of different presentation styles to determine if a listing is appropriate for the user's needs.

### SUMMARY OF THE SYSTEM

The system provides a method an apparatus for retrieving and normalizing third party listings. The system allows a user to use a single transaction system to search multiple sources of listings. Listings that are from outside the system (third party listings) are normalized by translating the listings into the format of the local system. The creator of the third party listing (i.e. the seller) is contacted and offered the chance to become a listing party on the local system. The local system presents the seller with a plurality of questions that aid in completing a more comprehensive and sellable listing. The system rewards disclosure on the part of the third party lister by providing a richer listing on the local system.

### BRIEF DESCRIPTION OF THE DRAWINGS

FIG. 1 is a flow diagram illustrating the functional operation of the system from the seller's viewpoint.

FIG. 2 is a flow diagram illustrating the operation of the profile step of the system.

FIG. 3 is an embodiment of a vehicle information entry system.

FIG. 4 is an example of a query to the seller in an embodiment of the system.

FIG. 5 is an example of data entry in one embodiment of the system.

FIG. 6 is an example of a price selection menu in an embodiment of the system.

FIG. 7 illustrates one embodiment of the number of options that a seller can choose for listing and advertising using the system.

FIG. 8 is a flow diagram illustrating an embodiment of the system where a potential buyer requests an inspection of a vehicle.

FIG. 9 is a flow diagram illustrating a self warranty operation in one embodiment of the system.

FIG. 10 is a flow diagram illustrating transaction completion in an embodiment of the system.

FIG. 11 is an example hardware embodiment of the system.

FIG. 12 is a flow diagram illustrating the operation of an embodiment of the normalization of the system.

FIG. 13 is a flow diagram illustrating the database search function of FIG. 12.

FIG. 14 is a flow diagram illustrating the third party search function of an embodiment of the system.

FIG. 15 is a flow diagram illustrating ad normalization in an embodiment of the system.

FIG. 16 is a flow diagram illustrating the transition of a third party seller to the local system.

FIG. 17 is a flow diagram illustrating the generation of a system “driver's license” in an embodiment of the system.

### DETAILED DESCRIPTION OF THE SYSTEM

The system provides a method and apparatus for the retrieval and normalization of third party listings. In the examples below, the system is described in connection with transactions involving automobiles. However, the system is not limited to such products and may be implemented with any goods and/or services without departing from the scope of the system.

The system provides useful tools for the seller, the buyer, and for completing the transaction. These tools and methods will be described below, followed by the description of the retrieval and normalization of third party listings.

Seller

We will initially describe the operation of the system from the standpoint of the seller. When a seller wishes to sell an automobile, the seller typically places an advertisement. This ad may be on the vehicle itself in the form of a placard, it may be posted publicly in a high traffic area such as a shopping center or busy street, it may be placed in a periodical such as a newspaper, it may be placed online, or it may be placed in any combination of the above. Another option for a seller is to use an online auction site, such as eBay, as a tool for selling the vehicle. A problem for the seller is not only choosing which medium in which to advertise the vehicle, but how to phrase the advertisement for maximum effect and how to price the vehicle properly for likely sale but adequate return.

Many sellers will rely on other ads that they have seen and attempt to copy an ad when marketing their own vehicle. In addition, a seller may rely on a third party valuation site, such as Kelly Blue Book (www.kbb.com) as a source for pricing information. Often the seller will overestimate or underestimate the condition and value of their vehicle and thus choose an in appropriate price that either delays or prevents sale, or costs the seller revenue.

The system automatically walks a seller through all the steps needed to market the vehicle in a professional manner that maximizes peer to peer sales potential. The system includes profiling of the vehicle, imaging, certification, listing and advertising, tracking and management, and buyer screening.

Operation of the System (Seller)

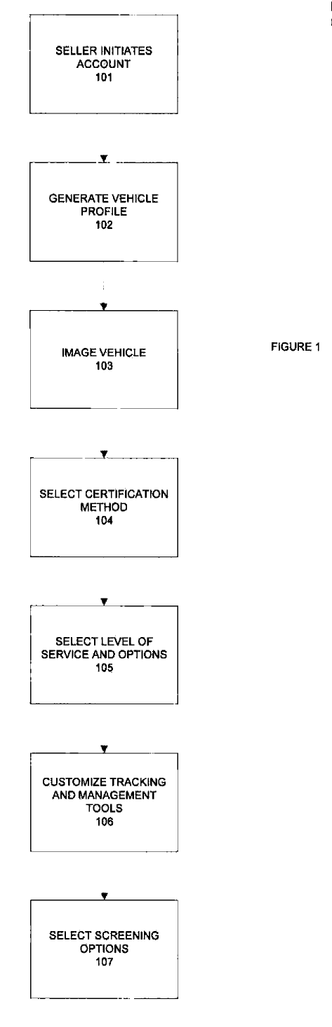

FIG. 1 is a flow diagram illustrating the functional operation of the system from the seller's viewpoint. At step 101 the seller signs up and creates an account in the system. At step 102 the vehicle profile is generated. In one embodiment of the system, the vehicle profile comprises a vehicle “biography” and a selling price. The system includes a method for aiding the seller in generating a biography that is useful for the particular vehicle and area where the vehicle is to be sold, and provides automatically generated information that allows the seller to intelligently price the vehicle.

At step 103 the system directs the seller to image the vehicle. This may be by uploading photographs of the vehicle or by requesting a service package where professional photographs are taken. Audio files, three-dimensional “virtual walkthroughs”, videos, and other types of vehicle imaging content may be uploaded as well. At step 104 the seller is prompted to select a certification method for the vehicle. This allows the seller to choose from a plurality of certification methods that have different pricing structures and may be initiated by the buyer instead of the seller. At step 105 the system presents selectable options associated with the level of service that the user has selected and includes choices for listing and advertising the vehicle. At step 106 the seller is given a chance to customize and select tracking and management tools. At step 107 the seller selects buyer screening options, including call center services.

Profile

Auto-Biography

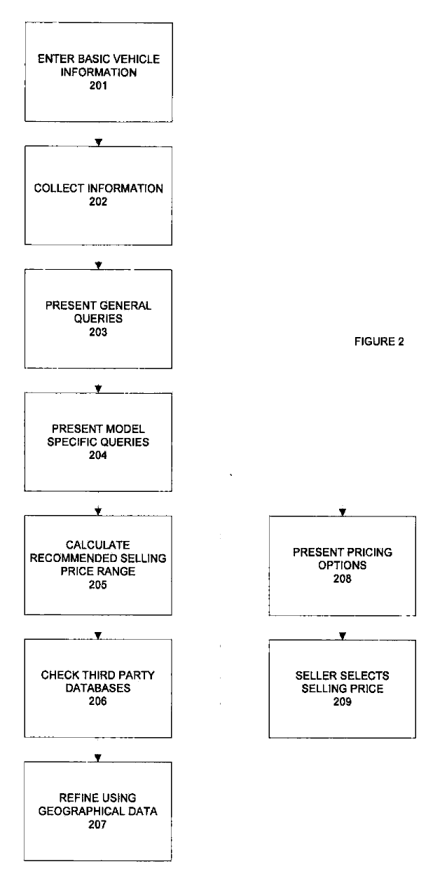

As noted above, the system prompts the user to profile the vehicle at step 102. This profile comprises a biography of the vehicle as well as selecting a selling price for the vehicle. FIG. 2 is a flow diagram illustrating the operation of the profile step of the system. At step 201 the seller enters basic information about the vehicle such as year, make, model and some other basic questions. This step collects information likely to be known by the seller that will assist in directing the seller in later steps of the process.

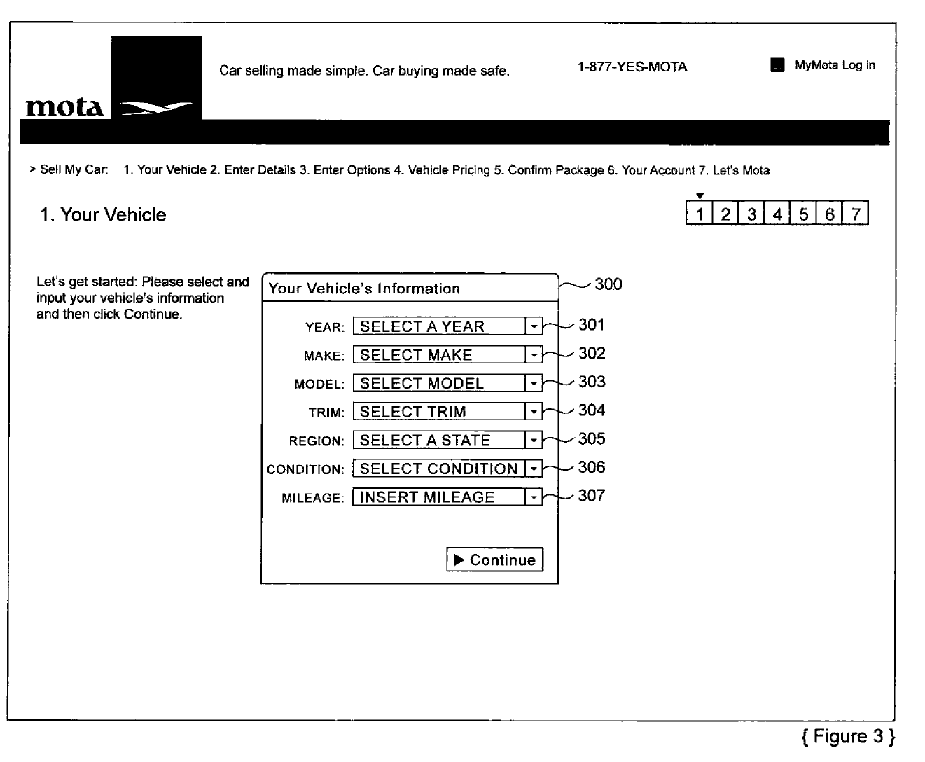

Referring briefly to FIG. 3, one embodiment of a vehicle information entry system 300 for implementing step 201 is illustrated. Here the seller chooses the year 301, make 302, and model 303 of the vehicle to be sold. In one embodiment, completion of the fields is done from top down, with each answer modifying lower fields so that appropriate choices are provided. For example, after the make 302 (e.g. Ford, Mercedes) is selected, the model menu 303 is populated only with models from that maker and made in the year selected at field 301. Similarly, the trim field 304 is populated only with options for that model of that year. The region (e.g. state) field 305 will affect later options presented to the seller as well (including some of the questions related to the biography of the vehicle as well as the price). The condition field 306 is often misunderstood by the seller but later questions that are customized for the vehicle aid in correctly describing the condition of the vehicle. Finally the seller enters the mileage 307 and proceeds to the next step.

Returning to FIG. 2, at step 202 the system collects the initial data entered by the seller in step 201 and retrieves a series of interactive queries for the seller that aid in providing more detail for the biography of the vehicle.

At step 203 the seller is presented with a series of general queries. In one embodiment, these questions are focused on the condition of the vehicle (interior, exterior, and mechanical), the everyday use of the vehicle, maintenance of the vehicle, extras, and a space for additional information that the seller may think is important.

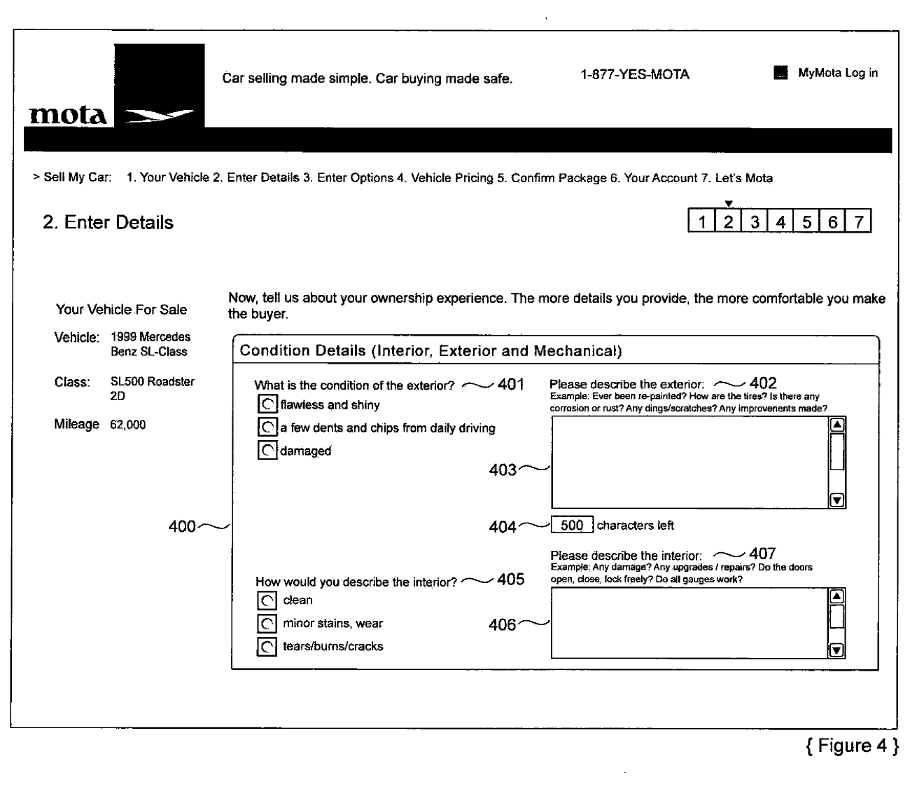

The system provides explanations of the queries and includes a text box where the seller can enter additional information as desired. Referring now to FIG. 4, and example of a query is illustrated. Query 400 relates to the condition of the vehicle exterior and interior. The seller is presented with three checkboxes 401 to generally describe the exterior of the vehicle. The user can simply select one of the boxes and proceed to the next query. Alternatively, the user can enter text into text box 403 to more fully describe the vehicle. This detail supplements (and possibly corrects) the choice of condition 306 selected in step 201.

The system provides helpful hints 402 about items that may be of interest. The seller can simply describe items of the vehicle that match up with the hints above a query box to provide a more useful biography of the vehicle. Alternatively, the seller can choose their own additional description if desired. In one embodiment, the system indicates how many characters the seller can still enter in the text box at box 404. In one embodiment, the system limits the amount of text the seller can enter as a method of keeping the vehicle biography more readable. The seller is presented with regions 405, 406, and 407 to indicate condition of the interior.

This system of guiding and directing the seller, as well as limiting the number of words, results in a vehicle biography that includes the kind of information that is useful to a buyer and/or in marketing a vehicle. Many times sellers do not know the kind or amount of information to include in a vehicle description, so the system removes the guesswork and uncertainty.

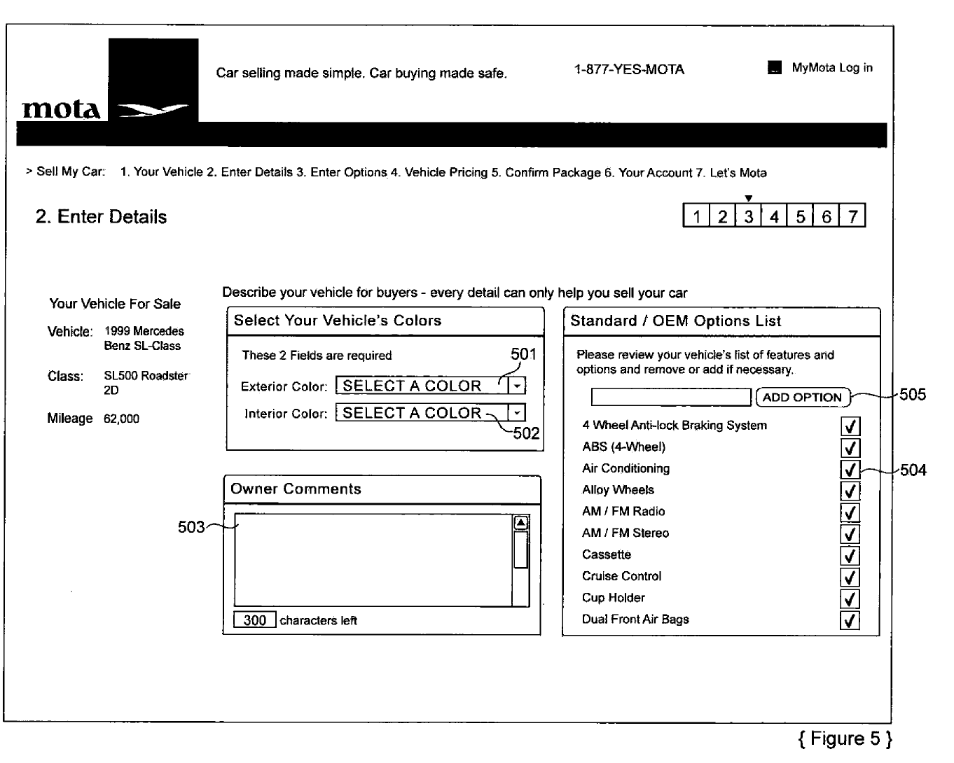

At step 204 the seller is presented with a series of queries that are specific to the year, make and model of the vehicle identified in step 201. Step 204 allows the user to specify certain descriptive features of the vehicle such as interior and exterior color, options, and any additional options or customizations that the vehicle may have. Referring briefly to FIG. 5, the system presents the user with data entry including required fields for exterior color 501 and interior color 502. If the color of the vehicle is not found in available colors of the pull down lists, the user can describe the color in text field 503. Region 504 lists the available options for the year, make, model, and trim level selected by the seller. The seller can de-select any of the options that do not apply and use field 505 to add options that may not be reflected in the list.

Pricing

At step 205 the system uses the data provided in the auto-biography to find a recommended price for the vehicle. The system checks third party databases at step 206. These databases can be sites such as Kelly Blue Book as well as eBay, on-line advertisements, or reported sales data from government resources. The system uses geographical data at step 207 to further customize the pricing algorithm. At step 208 the system provides the seller with pricing options. At step 209 the seller selects a price and confirms it to the system.

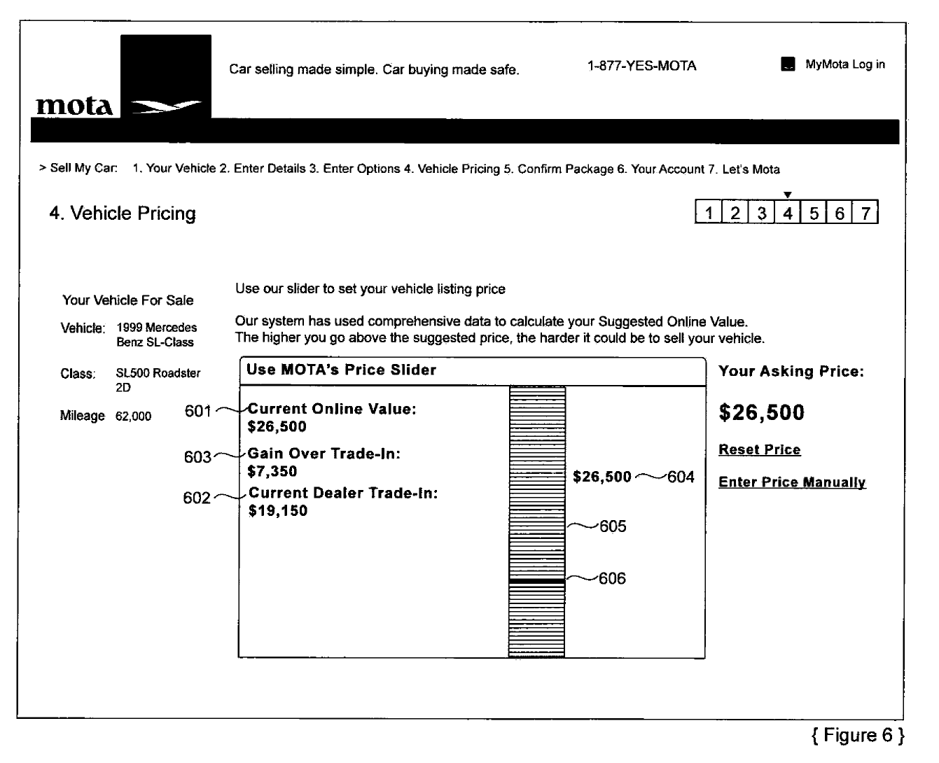

FIG. 6 is an example of a price selection menu in an embodiment of the system. The seller is presented with an estimated sales price 601 based on available data and vehicle profile. The current estimated trade-in value 602 is also provided. The system then provides the gain 603 of a peer-to-peer sale over a trade-in. This is useful information as it allows the seller to realize how flexible in the price to be while still achieving an advantage over simply trading in the vehicle. The menu allows the seller to grab the sales price slider 604 to the right of the bar 605 and simply move it up and down to set a selling price. The price displayed in the slider 604 changes automatically as the seller moves the slider 604 up and down. In addition, the gain value 603 is automatically recalculated as the slider moves so the seller can see how much of an advantage is achieved over trade-in for each new price.

A low price indicator bar 606 is defined on the slider scale to represent a minimum price below which the user should not consider setting the sales price. This minimum sales price is calculated by the system and is based on the profile information, location, time of year, and other relevant information, including the selling frequency of vehicles of that type and the number of competing vehicles of the same type or same category. It should be noted that the seller is free to set a sales price below that line 606 if desired. In addition, the user can manually enter a price instead of using the slider 604.

Imaging

The system provides the seller the ability to include images of the vehicle in the listings the user may choose. In one embodiment the system provides the option of the seller to take their own pictures or videos for use in the marketing of the vehicle. Optionally, the seller can optionally choose to have a professional third party photographer take images or videos of the vehicle. As will be seen below in Listing and Advertising, the number of images or videos that will accompany the vehicle depends on the selection by the seller of one of a plurality of listing options. Another embodiment of the system provides an option of the seller to take their own voice, record it over the telephone, and embed the generated audio clip in the marketing of the vehicle. Another embodiment of the system provides an option of the seller to upload videos or three-dimensional visualizations of the vehicle for use in the marketing of the vehicle.

Certification

One of the drawbacks in peer-to-peer sales is the lack of trustworthiness of the seller by the buyer. The buyer may have doubts about the actual condition of the vehicle and may not want to rely on the word of the seller. If there is a problem with the vehicle, the buyer may have no one to pursue to correct any problems or misrepresentations regarding the vehicle. This limitation can tend to lead the buyer to purchase from a commercial party such as a dealer so that some level of both trustworthiness or future liability can be had. For some buyers who wish to take advantage of peer-to-peer sales, one approach has been to have a trusted mechanic inspect the vehicle and report on condition and problems. This leads to inconvenience in arranging to have the vehicle provided to the mechanic and delays while the mechanic inspects the vehicle. Another problem is when the vehicle is at a distance from the buyer. The buyer may not be able to arrange for the vehicle to be delivered to a known mechanic and is then in the position of needing to find a mechanic in another town or city or even state to perform the inspection.

The system provides a number of solutions for problems associated with certification. In one embodiment, the seller may choose to have an inspection performed and then make the vehicle inspection report (VIR) available on-line as part of the listing. In another embodiment, the seller may have a VIR prepared but charge a nominal fee to view the VIR. This will tend to self select those viewing the VIR to more serious purchasers.

In another embodiment, the system provides information about a vehicle inspection service that the buyer can elect to use to have an inspection performed. This serves to further self select serious buyers. This is a step that would normally be taken by a serious buyer but is often made difficult by distance from the seller. By providing information about an inspection service as well as a published price for the inspection, the guesswork is removed on the part of the buyer. An advantage of this third party inspection is that it may include a warranty of some sort on the inspection (e.g. 30 days) that may give comfort to a buyer who otherwise would be wary of a peer-to-peer sale.

In one embodiment, the system has a relationship with a known national entity for the inspections. For example, the system may have a relationship with an entity such as Pep Boys. This provides the buyer with an independent and trusted inspection service, as well as assurance that the buyer will have recourse to an ongoing enterprise if there is any dissatisfaction. In other instances, the system offers a plurality of inspection services to the buyer. The buyer can choose the inspection service with which the buyer is most comfortable and initiate the inspection process.

In addition to a VIR, the system also offers the option of providing a vehicle history report, such as those provided by CARFAX or AutoCheck.

Listing and Advertising

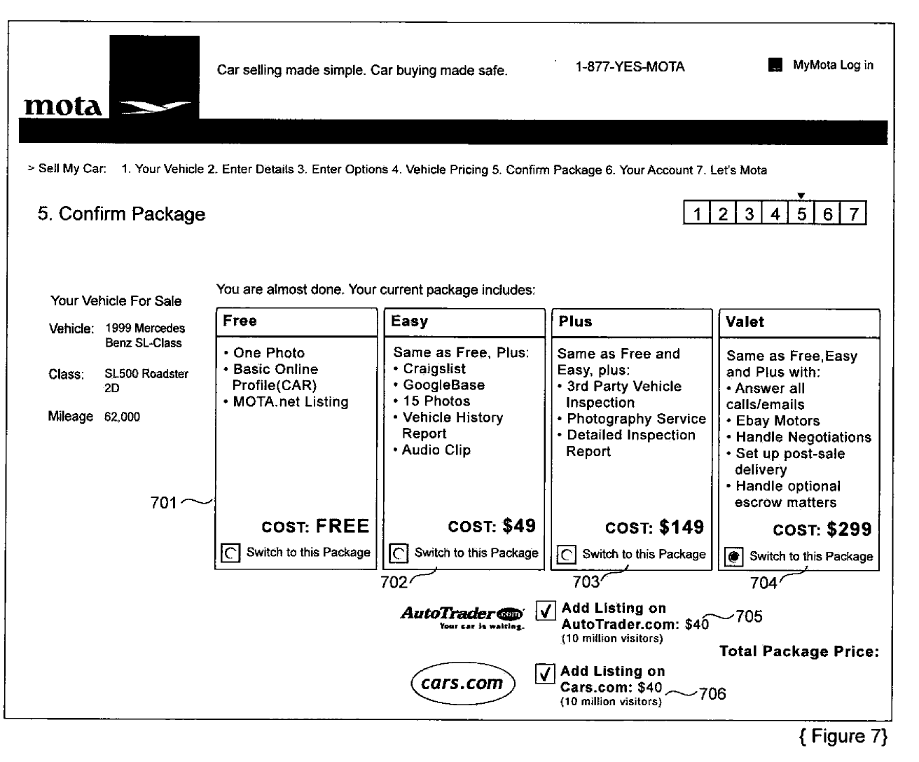

FIG. 7 illustrates one embodiment of the number of options that a seller can choose for listing and advertising using the system. The system provides in this embodiment four options 701, 702, 703, and 704. Option 701 is free to the seller in one embodiment and includes the right to include one image of the vehicle, the profile as generated by the interactive question process, and a listing on a vehicle listing service provided by the system (e.g. www.mota.com). Option 102 in this embodiment is an option that includes a fee for the seller (as do options 703 and 704). Option 702 includes additional listings (e.g. Craigslist and Autotrader, eBay motors, Yahoo, and the like) as well as the right to include up to fifteen images. This option 702 includes all options of the earlier option 701 plus a vehicle history report and an audio clip.

The audio clip is a sound file that is included with the online listing of the vehicle. The seller is prompted to record a sound file describing the car but answering the highest frequency questions that buyers typically have about vehicles, particularly the vehicle on sale. Even with the extensive data gathered from the seller and made available to potential buyers, there are still questions that the buyer wishes to hear discussed by the seller. The system anticipates this need and prompts the seller to answer these questions in a recorded voice file. The voice file is attached to the listing and potential buyers can choose to listen to it if desired. The goal of each listing is to reduce the need for the buyer to have direct communication with the seller for as deep into the process as possible. In this manner, the seller will only deal with actual potential buyers, avoiding the annoyance of dealing with multiple people.

Option 703 includes a third party vehicle inspection that a buyer can access either for free or for a relatively nominal fee, at the user's discretion. This option 703 also includes a professional photography service that come to the seller, takes professional photographs for use in the listing, and selects the best photographs to lead to a sale. This option 703 also includes a detailed inspection report.

Option 704 is the top option in this embodiment. This option provides a service where the system handles all communications with buyers. This eliminates the risk to the seller of visits or communications by strangers. It also includes listing on additional services (e.g. eBay motors).

Regardless of the option selected, the seller has the ability to choose additional listing media such as AutoTrader.com 705 and Cars.com 706 for additional fees.

Tracking and Management

The system provides the ability to track and manage the sale of the vehicle so that effort by the seller is reduced. The system can handle email inquiries about the vehicle and forward them to the seller. This prevents the buyer from having access to the seller's personal information. When the system call handling option is selected, the seller is insulated from all buyer communication, even after the sale is completed. This eliminates one of the prime prior art disadvantages of peer-to-peer vehicle sales, namely the discomfort and potential danger of interaction with and communication with strangers.

The system also provides other management operations. For example, in one embodiment, the system can track counteroffers to the sales price selected by the seller (if permitted). The system can compare these counteroffers to the selling price and make recommendations for adjusting the selling price. In addition, the system can track sales of similar vehicles in similar geographic areas and inform the seller of real world selling prices that may cause the seller to adjust the price (up or down).

Buyer

The buyer experience is also improved with the system. Some of the disadvantages of prior art peer-to-peer transactions from the buyer standpoint include lack of trustworthiness in the condition of the vehicle, lack of accessibility to the seller, inability to inspect the vehicle, lack of availability of financing, insurance, and warranty, and lack of recourse after a sale. The system provides improvements and solutions for all of these buyer disadvantages.

The buyer experience is in part defined by the options that the seller has selected and in part by the options that the buyer chooses to take advantage of When the seller has selected the highest option level, the buyer is provided with the maximum amount of information about the vehicle including multiple images taken by a third party, a vehicle history report, and a VIR.

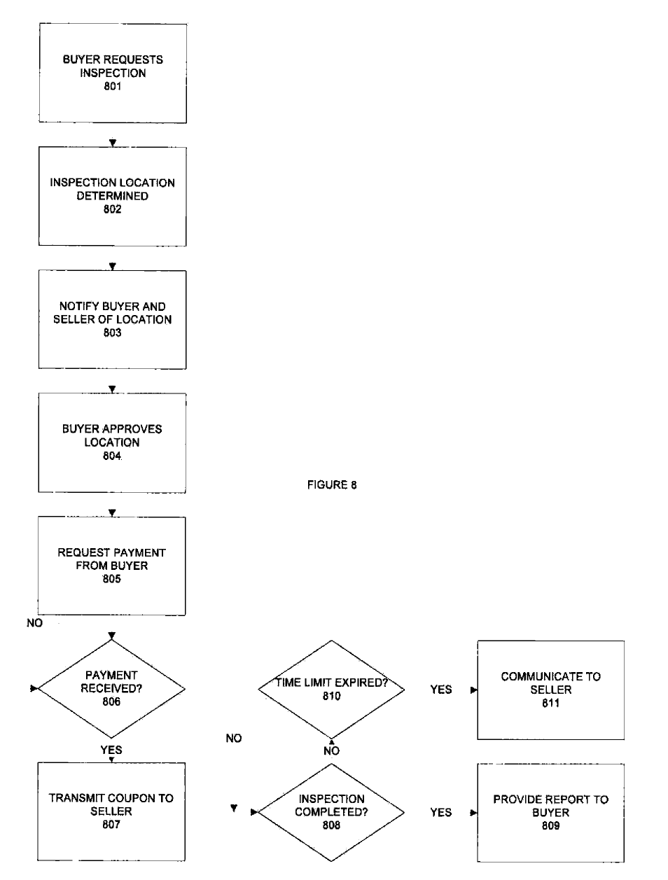

FIG. 8 is a flow diagram illustrating an embodiment of the system where a potential buyer requests an inspection of a vehicle. At step 801 a buyer indicates that an inspection is requested. At step 802 the system determines available inspection locations near the seller. The inspection location may be one pre-selected by the seller or may be an inspection location already in a partner relationship with the system and near the seller. (In one embodiment of the system, partnerships are formed with regional or national repair and parts centers, such as Pep Boys, Sears Automotive, Aamco, and others). After an inspection location has been determined, the system notifies the seller at step 803 of the inspection location. If the buyer approves the inspection location at step 804, the system requests payment from the buyer at step 805.

At decision block 806 the system determines if the payment has been received. If not, the system returns to step 805. If so, the system transmits a coupon to the seller at step 807. The coupon covers the expense of obtaining the vehicle inspection at the selected inspection location. The coupon also instructs the inspection location to forward a copy of the inspection results to the buyer at a provided address, or to the system via electronic transfer. The seller is encouraged to obtain the inspection quickly. The system sets a time limit within which the seller must schedule the inspection. At decision block 808 the system determines if the seller has had the car inspected. If so, the system provides the inspection report to the buyer at step 809.

If the seller has not had the vehicle inspected, the system proceeds to decision block 810 and checks to see if the time limit for inspection has expired. If not, the system returns to step 808. If so, the system proceeds to step 811 and communicates to the seller that the deadline has passed. In one embodiment, the seller need only make the vehicle available and a system representative will transport the vehicle to the inspection location.

Self Warranting

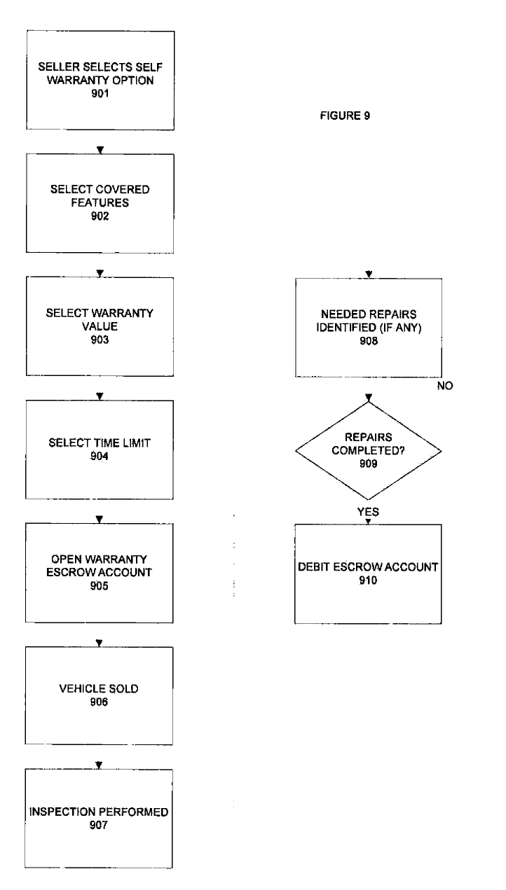

In one embodiment of the system, the seller designates in the sellers listing that the seller will self warrant the vehicle. This is to remove the need to have an inspection performed prior to sale and to facilitate more rapid turnaround from listing to sale. The seller will provide disclosure of possible problems and identify certain items on the vehicle that the seller will warrant. In the flow diagram of FIG. 9, the seller chooses self warranty at step 901. At step 902 the seller selects those features of the vehicle to be covered by the warranty. At step 903 the seller selects the total amount of warranty value (e.g. $2,000.00) and at step 904 the time limit of the warranty (e.g. 3 days). At step 905 the system creates an escrow account for the warranty amount to be held for the time limit of the warranty.

At step 906 the vehicle is sold to a buyer and the buyer receives the warranty and a coupon for an inspection at an approved inspection location. The buyer then has the inspection performed at step 907. At block 908 the report indicates repairs necessary on the vehicle. At decision block 909 it is determined if any of the indicated repairs are covered by the warranty. If so, at step 910 the escrow account is debited for those items up to the total warranty (optionally minus a deductible amount, e.g. $500.00). The remainder, if any, of the escrow amount is returned to the seller. If none of the indicated repairs are covered by the warranty, the escrow amount is returned to the seller and the transaction is complete.

The advantage to the seller of providing a self warranty is that the seller is in the best position to know the reliability and condition of the vehicle. At the same time, the escrowed warranty amount takes the question of trust out of the hands of the buyer. A buyer is not incentivized to get a car inspection when the buyer is not sure if they will be the successful bidder. The self-warranty option means that only the winning bidder needs to pay for an inspection and yet has a source of compensation if things are not as they are described.

Complete Transaction

The system also provides additional features that fill in the gaps between a commercial transaction and a peer-to-peer transaction. The system provides a way to refer customers to third party providers who may handle paperwork, title transfer, transport of the vehicle (if needed), financing, insurance, and post-sale continuing warranty.

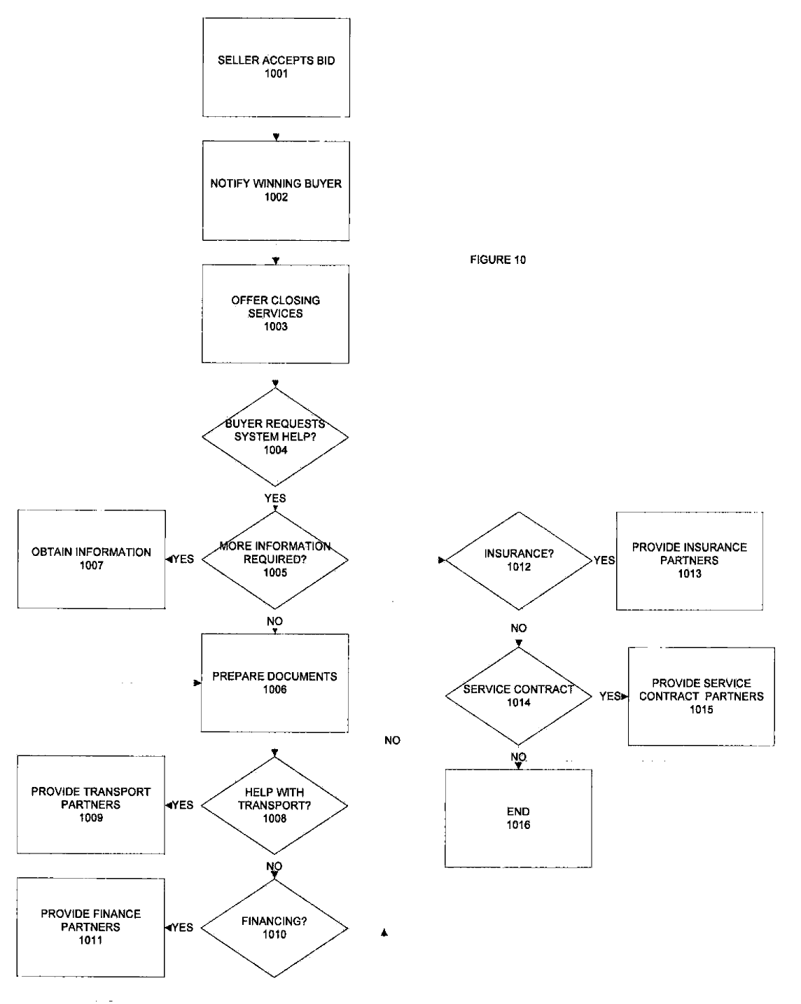

FIG. 10 is a flow diagram illustrating how the system operates at the close of a transaction. At step 1001 a seller accepts a bid which ends the selling part of the process. At step 1002 the system notifies the buyer that they buyer has won the bid and can now transfer ownership of the vehicle. At step 1003 the system offers the buyer the opportunity to participate in a number of closing services offered by the system. At decision block 1004 it is determined if the buyer wants the system to handle the paperwork of the transaction. If so, the system checks at decision block 1005 if it has the necessary information to prepare the transfer documents. If so, the system proceeds to prepare the transfer documents at step 1006.

If the system needs information at step 1005, it requests data from the buyer at step 1007 and then proceeds to step 1006. If the buyer does not want assistance with the paperwork at step 1004 or after step 1006, the system determines if the buyer needs assistance from a third party provider with the transport of the vehicle at step 1008. If so, the system provides the buyer at step 1009 with the opportunity to contract with a third party provider for transport of the vehicle.

If not, the system proceeds to step 1010 to determine if the buyer needs financing to complete the transaction. If so, the system includes financing options and initiates the financing process at step 1011. If the buyer does not need financing at step 1010, the system proceeds to step 1012 to determine if the buyer needs vehicle insurance. If so, the system offers at step 1013 insurance options from system partners. If not, the system determines at step 1014 if the buyer is interested in a continuing service contract on the vehicle. If the buyer desires a service contract, at step 1015 the system provides options from system partners. If not, the system exits at step 1016 and the sale is concluded as described below.

If the buyer does not want to take advantage of the services offered by the system or from third party providers, the buyer can complete the transaction under the terms established by the seller. The seller can require a particular form of payment (e.g. cashier's check, certified check, wire transfer, cash, etc.). The seller may also wish to remain out of contact with the buyer and have transactions finalized by system representatives or third party providers. If the seller handles it personally, the system allows the buyer and seller to be in communication through the system through non-system channels as desired.

Retrieval and Normalization of Third Party Listings

Seller Flow

In one embodiment of the system, the buyer is able to access ads placed on third party systems via the local system. In other words, the buyer is able to see listings from the local system from sellers who originally chose to list their vehicles on the local system, as well as listings by sellers who chose to list their vehicles on third party systems, such as eBay, yahoo, craigslist, recycler, autotrader, and the like.

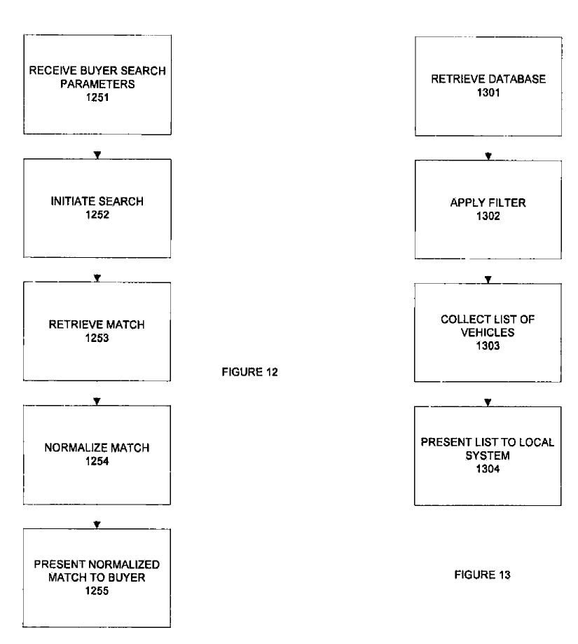

FIG. 12 illustrates an embodiment of this system. At step 1251, when the buyer inputs the type of car that the buyer is seeking, the system searches all vehicles at step 1252 on the local system to provide appropriate matches. The buyer is able to identify desired vehicles by a number of factors, including make, model, model year(s), mileage, price, color, distance from buyer, body type, or any combination thereof. In addition to the local database, the system searches third party systems at step 1252 for matching vehicles at step 1253 and presents them to the buyer. The third party listings are normalized at step 1254 as much as possible to present them at step 1255 in the same format as the local system. In that manner, the buyer can easily go through multiple listings and identify vehicles of interest.

The search feature of step 1252 is shown in more detail in FIG. 13. At step 1301 the system retrieves a database of third party ads. At step 1302 the system applies a filter to the third party ads based on the vehicle of interest of the user. The number of filters depends upon how specific the user has been in selecting vehicles of interest. For instance, the user may have only identified a make, model, and model year. In other cases, the user may have identified one or more of mileage, color, options, price range, distance from buyer, and the like. When other options are available, those may be added as filters to narrow down the vehicle choices. In one embodiment, the system may offer vehicles that are within certain parameter of the users choices. At step 1303 the system collects the list of vehicles that match the filter settings. At step 1304 the list is provided to the local system for further processing.

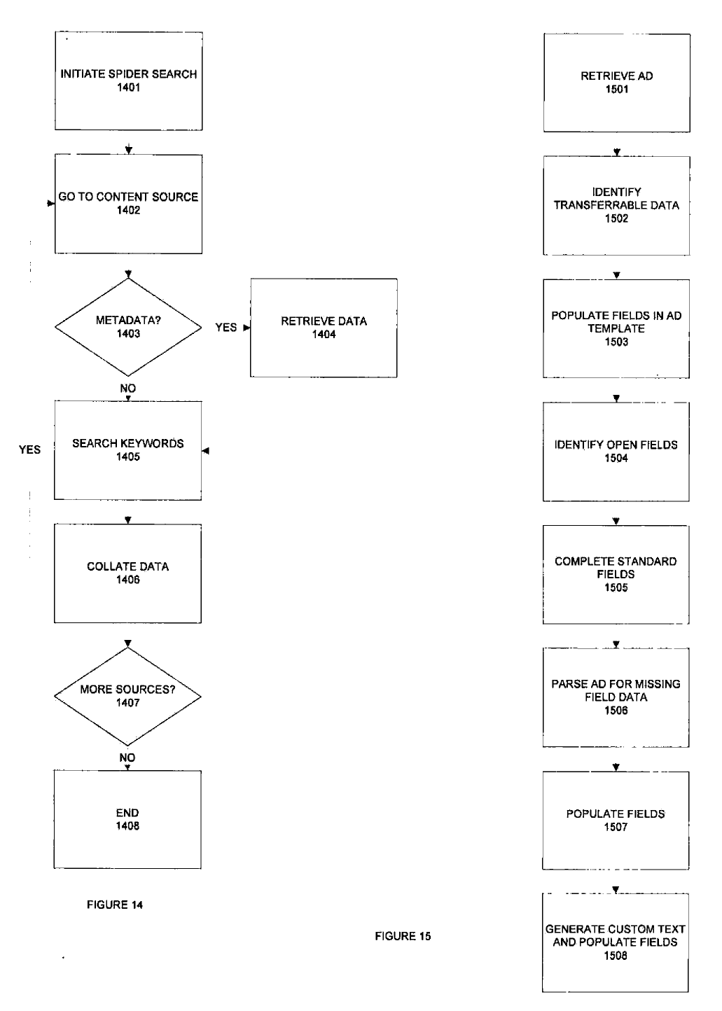

FIG. 14 is a flow diagram illustrating one embodiment of the system for creating a database of vehicles from third party sources. At step 1401, the system initiates a so-called “spider” search via the internet of other web sites that offer vehicles for sale. At step 1402 the system goes to a content source, i.e. a third party vehicle sale site. AT step 1403 the system determines if the site utilizes metadata to define fields and terms. (Note, some sites use some combination of defined and undefined fields. In some cases, a site might not use metadata for a particular term that is defined by metadata in the local system.) If the site provides at least some metadata, the system proceeds to step 1404 and retrieves the tagged data. If not, or after the metadata has been retrieved, the system searches keywords on the site at step 1405 to collect more information. The keyword searches are compared to translation database to convert a plurality of search terms to a form that is understandable and usable by the local system. For example, a third party ad may list a vehicle having a “4.2” or a “2.8”. The local system interprets those numbers as engine sizes and populates the engine field with that information. (The system can compare suspected engine size with actual available sizes for the make, model, and year of the vehicle to confirm).

At step 1406 the data is collated. At step 1407 the system checks to see if more sites or content sources need to be searched. If so, the system returns to step 1402. If not, the system ends at step 1408.

In one embodiment, the spider search is ongoing on a nearly continuous basis. The system can check to see if previously discovered third party search vehicles are still listed and can make a determination on whether to remove them from the local database when the ad for a particular vehicle is not found in a subsequent search.

Although the system continuously searches the third party sources for vehicles, in one embodiment the system only provides such a vehicle to the local system when a specific search for that vehicle is performed. There may be regulations governing the use of third party ads and the system includes safeguards for compliance with such regulations. For example, the local system does not contact the seller of third party ads. However, the system provides a mechanism for the buyer using the local system to contact the seller of a third party site.

FIG. 15 is a flow diagram illustrating the operation of normalizing a third party ad (step 1254 of FIG. 12) to comply with the format of the ad on the local system. At step 1501 the system retrieves an ad that originated in a third party system. This ad may come from the local database of third party ads collected as described in FIG. 14 or may be retrieved during a current search. At step 1502 the system identifies the information in the retrieved ad that can be easily transferred for use in the ad template of the local system. At step 1503 the system populates the fields of the ad template that can be completed with the information from step 1502.

At step 1504 the system identifies incomplete or empty fields of the ad template. At step 1505 the system populates those fields that can be populated by standard descriptions that may be common to all vehicles of the particular make, model, year, and option packages. This data may be pre-scripted at the local site or may be retrieved from a manufacturer's web site as desired.

At step 1506 the system parse the third party ad for data to populate remaining empty or incomplete fields. This may be accomplished by a text search of the third party ad for keywords that relate to any uncompleted fields. At step 1507 those fields are then populated with the parsed data.

Certain fields of the local ad template may be custom generated as described in co-pending patent application Ser. No. 12/191,181 filed Aug. 14, 2008 entitled “Automatic Ad Generation” and incorporated by reference herein in its entirety. At step 1508 the custom text is generated and those custom fields are populated as appropriate. The third party ad is thus normalized for presentation in the local system.

Transitioning Seller to Local Database

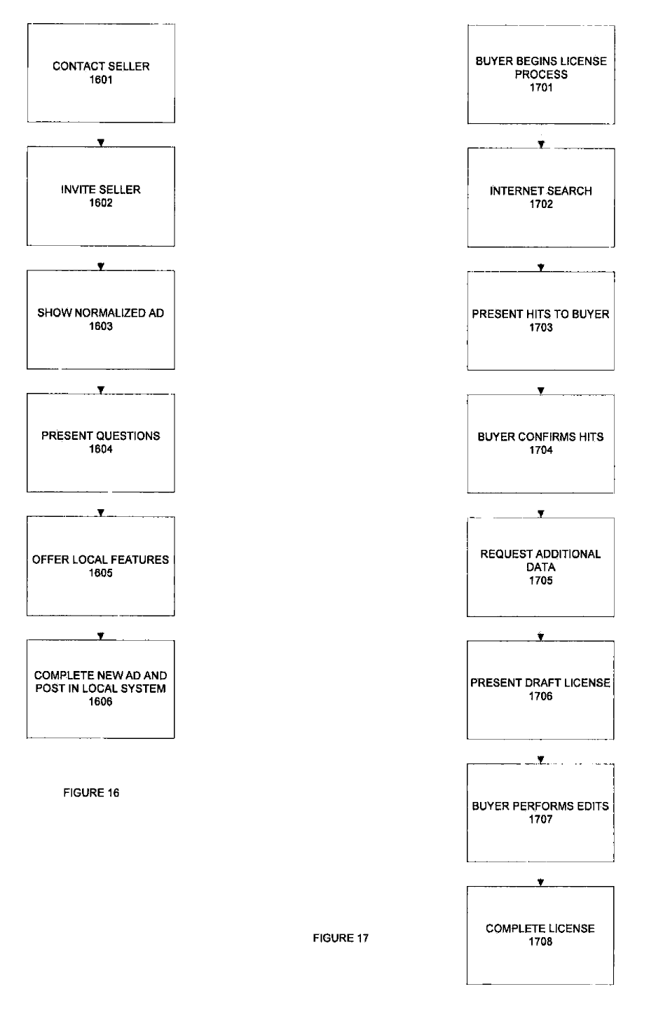

When a buyer has indicated an interest in a third party listing, the local system begins communication with the seller of the third party listing to let them know that a local system buyer has expressed interest. An embodiment of this communication is illustrated in connection the flow diagram of FIG. 16. At step 1601 the seller is contact via the system on behalf of a buyer who has expressed interest. The local system then invites the third party seller at step 1602 to add their third party listing to the local system listing service. The third party seller is presented with the normalized ad at step 1603 that has been generated by the local system based on the information in the original third party ad. At step 1604 the third party seller is provided with an interactive questionnaire similar to that presented to a listing party as in FIGS. 1-7 listed above. In this case the questionnaire is customized so that information that is already present is not requested again. By working through the interactive questions, the seller helps refine the listing to more appropriately fit in with the local system listing format.

The local system also at step 1605 offers the third party seller to participate in the local system features such as inspection services, CARFAX report, and the like. The seller can also be given information about the buyer before deciding whether to participate in the local system. In one embodiment, the local system also offers suggestions to the third party seller on modifying terms of the listing to increase sales. For example, the local system may indicate the likelihood of successful sale of similar vehicles at different price ranges to encourage the third party seller to modify the price in the listing. The local system may also indicate the increased likelihood of sale when there is an inspection or CARFAX report. Further, in one embodiment of the local system, the third party seller is offered the ability to list the vehicle on multiple listing services in addition to the original third party listing service and the local system listing service. The third party seller can be given the opportunity on the local system to list the vehicle on ebay, yahoo, craigslist, recycler, autotrader, and other systems to increase the likelihood of sales. At step 1606 the system completes the new ad for the third party seller and adds it to the local system.

Buyer Flow

When a buyer shows interest in a vehicle, the local system encourages the buyer to provide additional information to allow a seller to have more trust in the buyer and thus increase the likelihood of sale. In one embodiment this is referred to as a “buyer's driver's license” and is generated via a number of steps, including interactive questioning with the buyer. An embodiment of this process is illustrated in FIG. 17.

At step 1701 the buyer agrees to generate a license for use in the system. In one embodiment, at step 1702 the local system does an internet search of the buyer's name and email account to find possible matches and links to the buyer. This can include myspace, facebook, and other social networking sites. The system presents the buyer with possible matches at step 1703, including photographs of the buyer found online and queries the buyer to confirm their identity. In presenting matches, the local system may indicate the increased likelihood of sales when a buyer provides more information. At step 1704 the buyer confirms which retrieved results are in fact the buyer.

At step 1705 the system request additional data that is in addition to, or to supplement, the information found in the search. For example, the buyer's driver's license could also indicate preferred method of payment (finance, cash, etc.) as well as existing auto insurance, whether a test drive is needed, inspection required, CARFAX required, etc.

The system generates a draft license at step 1706 and presents it to the buyer. At step 1707 the buyer edits the license by approving or deleting fields and images of the license.

After the buyer's driver's license is complete at step 1708, it can be sent to the seller and the two parties can communicate between themselves at that point if desired, or it can be done through the system as described above.

Whenever a buyer shows interest in any listing, whether local system or third party system, the buyer is presented with other matching vehicles and is offered the opportunity to show the same interest and ask the same questions to any sellers of vehicles which are selected by the buyer. When matching vehicles are available, the local system continues to inform the buyer of these matches so that the buyer is always aware of potential better deals or better matches with the buyer's requirements.

In one embodiment, the system is constantly monitoring third party listing services and collecting a database of available cars. However, the system does not contact those sellers or attempt to add the listings to the local site until a buyer has initiated a search that results in a match to one or more of the third party listings.

Embodiment of Computer Execution Environment (Hardware)

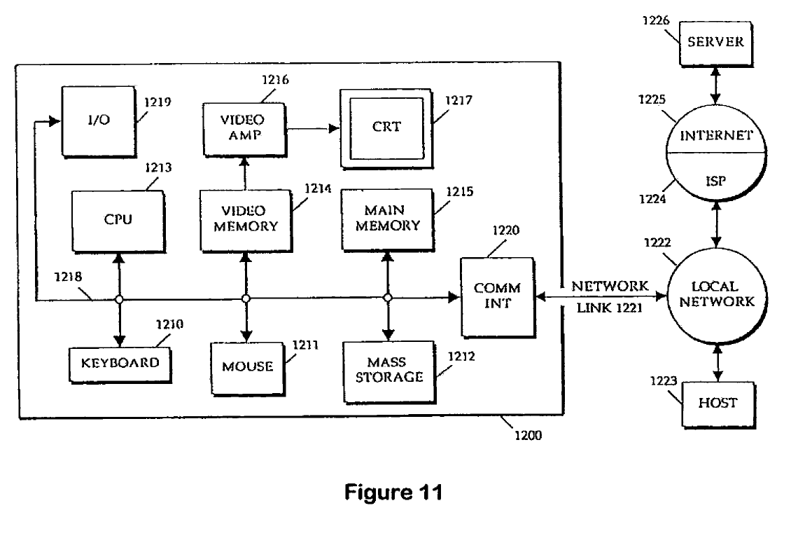

An embodiment of the system can be implemented as computer software in the form of computer readable program code executed in a general purpose computing environment such as environment 1200 illustrated in FIG. 11, or in the form of bytecode class files executable within a Java™ run time environment running in such an environment, or in the form of bytecodes running on a processor (or devices enabled to process bytecodes) existing in a distributed environment (e.g., one or more processors on a network). The system may also be implemented on any suitable computing device such as a PDA, mobile phone, mobile computing device, as a software service hosted on a server, an ethereal network based implementation, or any other suitable processing environment.

In the system of FIG. 11, a keyboard 1210 and mouse 1211 are coupled to a bidirectional system bus 1218. The keyboard and mouse are for introducing user input to the computer system and communicating that user input to central processing unit (CPU) 1213. Other suitable input devices may be used in addition to, or in place of the mouse 1211 and keyboard 1210. I/O (input/output) unit 1219 coupled to bidirectional system bus 1218 represents such I/O elements as a printer, A/V (audio/video) I/O, etc.

Computer 1200 includes a video memory 1214, main memory 1215 and mass storage 1212, all coupled to bi-directional system bus 1218 along with keyboard 1210, mouse 1211 and CPU 1213. The mass storage 1212 may include both fixed and removable media, such as magnetic, optical or magnetic optical storage systems or any other available mass storage technology. Bus 1218 may contain, for example, thirty-two address lines for addressing video memory 1214 or main memory 1215. The system bus 1218 also includes, for example, a 32-bit data bus for transferring data between and among the components, such as CPU 1213, main memory 1215, video memory 1214 and mass storage 1212. Alternatively, multiplex data/address lines may be used instead of separate data and address lines.

In one or more embodiments of the invention, CPU 1213 is a microprocessor manufactured by IBM, Intel, AMD, Sun Microsystems or any other manufacturer. However, any other suitable microprocessor or microcomputer may be utilized. Main memory 1215 is comprised of dynamic random access memory (DRAM).

Video memory 1214 is a dual-ported video random access memory. One port of the video memory 1214 is coupled to video amplifier 1216. The video amplifier 1216 is used to drive the cathode ray tube (CRT) raster monitor 1217. Video amplifier 1216 is well known in the art and may be implemented by any suitable apparatus. This circuitry converts pixel data stored in video memory 1214 to a raster signal suitable for use by monitor 1217. Monitor 1217 is a type of monitor suitable for displaying graphic images.

Computer 1200 may also include a communication interface 1220 coupled to bus 1218. Communication interface 1220 provides a two-way data communication coupling via a network link 1221 to a local network 1222. For example, if communication interface 1220 is an integrated services digital network (ISDN) card or a modem, communication interface 1220 provides a data communication connection to the corresponding type of telephone line, which comprises part of network link 1221. If communication interface 1220 is a local area network (LAN) card, communication interface 1220 provides a data communication connection via network link 1221 to a compatible LAN. Wireless links are also possible. In any such implementation, communication interface 1220 sends and receives electrical, electromagnetic or optical signals which carry digital data streams representing various types of information.

Network link 1221 typically provides data communication through one or more networks to other data devices. For example, network link 1221 may provide a connection through local network 1222 to host computer 1223 or to data equipment operated by an Internet Service Provider (ISP) 1224. ISP 1224 in turn provides data communication services through the world wide packet data communication network now commonly referred to as the “Internet” 1225. Local network 1222 and Internet 1225 both use electrical, electromagnetic or optical signals which carry digital data streams. The signals through the various networks and the signals on network link 1221 and through communication interface 1220, which carry the digital data to and from computer 1200, are exemplary forms of carrier waves transporting the information.

Computer 1200 can send messages and receive data, including program code, through the network(s), network link 1221, and communication interface 1220. In the Internet example, server 1226 might transmit a requested code for an application program through Internet 1225, ISP 1224, local network 1222 and communication interface 1220. In accord with the invention, one such downloaded application is the method and apparatus for creating, editing and displaying works containing time-dimensioned textual components described herein.

The received code may be executed by CPU 1213 as it is received, and/or stored in mass storage 1212, or other non-volatile storage for later execution. In this manner, computer 1200 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the system may be implemented in any type of computer system or programming or processing environment.

Thus, a method and apparatus for peer-to-peer sales is provided.

What is claimed is:

1. A method for providing peer-to-peer sales comprising:
inputting search parameters by a buyer;
searching a local system listing service and a plurality of third party listing services for one or more listings that match the parameters;
normalizing a matching listing from the third party listing services to a local system format;
presenting the normalized listing to the buyer.

2. The method of claim 1 wherein the normalizing comprises:
identifying metadata in the third party listing;
using any metadata to populate corresponding fields in the local system.

3. The method of claim 2 further including searching keywords in the third party listing and using any keywords to populate appropriate fields in the local system.

4. The method of claim 1 wherein the normalizing comprises:
identifying transferable data from a third party listing;
populating corresponding fields in a local system ad template with the transferrable data;
identifying open fields comprising standard and non-standard fields;
completing the standard fields using standard data;
parsing the third party listing for open non-standard field data;
populating the open non-standard fields with parsed data.

5. The method of claim 4 further including generating custom text to populate any remaining open fields.
